(19) United States
(12) Patent Application Publication
(10) Pub. No.: US 2016/0215140 A1
(43) Pub. Date: Jul. 28, 2016

(54) DIMENSIONALLY STABLE POLYCARBONATE-POLYALKYLENE TEREPHTHALATE MOULDING COMPOUNDS

(71) Applicant: COVESTRO DEUTSCHLAND AG, Leverkusen (DE)

(72) Inventors: Ralf HUFEN, Duisburg (DE); Thomas ECKEL, Dormagen (DE); Uli FRANZ, Solingen (DE)

(21) Appl. No.: 14/917,969

(22) PCT Filed: Sep. 10, 2014
(86) PCT No.: PCT/EP2014/069245

§ 371 Date: Mar. 10, 2016

(30) Foreign Application Priority Data
Sep. 11, 2013 (EP) 13183941.7

(51) Int. Cl. C08L 69/00

(52) U.S. Cl. CPC C08L 69/00; C08L 2205/06

(57) ABSTRACT

The present invention relates to dimensionally stable compositions comprising
A) 50 to 70 parts by weight of at least one aromatic polycarbonate,
B) 16 to 30 parts by weight of at least one polyalkylene terephthalate,
C) 4 to 30 parts by weight of at least one mineral filler based on talc,
D) 0.1-8.0 parts by weight of additives,
   with component D comprising at least one mould release agent and at least one stabilizer
      and with the sum of the parts by weight of components A-D making 100.

The present invention further relates to the use of the thermoplastic moulding compounds for producing dimensionally stable preforms and mouldings, and also to the preforms and mouldings obtainable from the thermoplastic moulding compounds. The preforms and mouldings find preferred application in motor vehicle construction, more preferably as exterior components.

The present invention relates to dimensionally stable compositions based on polycarbonate-polyalkylene terephthalate blends, which as mineral filler comprise talc and as additives comprise at least one mould release agent and at least one stabilizer. The present invention further relates to the use of the thermoplastic moulding compounds for producing dimensionally stable preforms and mouldings, and also to the preforms and mouldings obtainable from the thermoplastic moulding compounds. The preforms and mouldings find preferred application in motor vehicle construction, more preferably as exterior components.

Filler-containing polycarbonate moulding compounds (PC moulding compounds) which comprise partially crystalline polyesters and mineral fillers are known. Such moulding compounds are used for example in the motor vehicle sector.

EP 1 992 663 A1 discloses polycarbonate compositions comprising a further thermoplastic and talc. Among the further thermoplastics disclosed are polyesters. The compositions are notable for simple production in extrusion processing, stiffness, flame retardance, impact strength and thermal stability.

U.S. Pat. No. 5,637,643 discloses compositions comprising polycarbonate, polyester, and surface-modified talc, along with a phosphite-based antioxidant. The compositions are notable for good mechanical properties and good thermal stability.

JP 2010-275449 discloses compositions comprising polycarbonate, polyester, talc and carbon fibre. As a comparison, compositions without carbon fibre are also disclosed. The compositions according to that invention are notable for low thermal expansion, high stiffness and good surface properties.

JP 1995-101623 discloses compositions comprising polycarbonates, polyesters, acrylate rubber and talc plus antioxidant. The compositions are suitable for producing vehicle parts and are notable for high stiffness and good surface smoothness.

JP 1994-097985 discloses compositions comprising polycarbonate, talc, aromatic polyester and organic phosphoric ester. The compositions have high stiffness, good surface properties and high impact strength, and are suitable for producing mouldings with high thermal stability and mechanical strength.

None of these documents discloses compositions which comprise as additives at least one mould release agent and at least one stabilizer.

DE-A 19 753 541 discloses polycarbonate moulding compounds which comprise partly aromatic polyesters, graft copolymers and mineral fillers, with sufficient impact strength for exterior bodywork components. The moulding compounds claimed, however, exhibit inadequate heat distortion resistance.

EP-A 135 904 describes polycarbonate moulding compounds which comprise polyethylene terephthalate, polybutadiene-based graft copolymers and talc in an amount of up to 4 wt %. The advantage disclosed is a favourable combination of properties made up of low warpage and high impact strength.

JP-A 08 176 339 describes polycarbonate moulding compounds which comprise talc as mineral filler. ABS resins, polyethylene terephthalate and polybutylene terephthalate may be employed as further blend partners. Advantages emphasized for the moulding compounds are high impact strength and surface quality.

JP-A 07 025 241 describes polycarbonate moulding compounds which exhibit high stiffness and good surface quality. The moulding compounds comprise 60 to 70 wt % of polycarbonate, 20 to 30 wt % of polyester, 5 to 10 wt % of acrylate rubber and 5 to 10 wt % of talc and also 0.1 to 1 part by weight (based on 100 parts of polymer components) of antioxidant.

JP-A 63 132 961 discloses compositions comprising polybutylene terephthalate, polyesters, graft copolymers and mineral fillers for applications in the motor vehicle sector.

EP 1 355 988 A1 discloses polycarbonate moulding compounds, which may optionally comprise polyesters and/or graft copolymers, and which have a total iron content of less than 100 ppm—substantially resulting from added talc.

Exterior bodywork components made from plastics generally require coating. In the case of plastics coloured in car colour, the ancillary bodywork components produced from them are generally coated with one or more coats of transparent coating materials. In the case of plastics not coloured in car colour, the ancillary bodywork components produced from them are painted with a number of coats of paint, with at least one of the coats imparting colour. The applied coats of paint must generally be baked and cured at elevated temperature. The temperature needed for this, which can be up to 200° C., and duration are dependent on the paint systems used. In the course of the curing and/or baking operation, the plastics material of the ancillary bodywork components should as far as possible not show any alteration, such as irreversible deformation, for example. It is therefore necessary to provide thermoplastic polycarbonate moulding compounds that have high heat distortion resistance.

Furthermore, in their daily use as well, the components are required to retain high dimensional stability, more particularly a low coefficient of linear thermal expansion (CLTE), in all dimensions.

Further requirements imposed on ancillary bodywork components made from plastics are high impact strength under impact and tensile load, including in particular at low temperatures, sufficient stiffness, good surface quality, good paintability with effective paint adhesion, and good chemical and fuel resistance. The moulding compounds that are used to produce the exterior bodywork components must, moreover, have high flowability in the melt.

Practical experience shows that depending on the particular area of use, materials employed for ancillary bodywork components may exhibit great variations in the properties listed. Ultimately decisive, and very important for all materials, however, is a sufficient heat distortion resistance and dimensional stability, in order to allow trouble-free painting and to prevent warpage of the components with cracking and change in the gap dimensions.

The object was to develop dimensionally stable polycarbonate/polyalkylene terephthalate compositions with low CLTE, preferably in all dimensions, in combination with high impact strength, high modulus of elasticity, good flowability, high heat distortion resistance and reduced contraction in thermoplastic processing.

The polycarbonate moulding compounds ought further to have an excellent profile of overall properties, including paint adhesion for ancillary bodywork components made from plastics, in relation to the requirements specified in the section above. The polycarbonate moulding compounds, moreover, ought to be readily processable into large mouldings suitable for use as ancillary bodywork components.

It has now been found that compositions comprising polyalkylene terephthalate in combination with polycarbonate, and talc as mineral filler, exhibit the required properties.

The present invention relates to compositions comprising
A) 50 to 70, preferably 52 to 68, more preferably 54 to 66, more particularly 55 to 65 parts by weight of at least one aromatic polycarbonate,
B) 16 to 30, preferably greater than 18 to 28, more preferably 20 to 26, more particularly 21 to 25 parts by weight of at least one polyalkylene terephthalate,
C) 4 to 30, preferably 5 to 25, more preferably 8 to 22, more particularly 9 to 21 parts by weight, most preferably 12 to 18 parts by weight, of at least one mineral filler based on talc,
D) 0.1-8.0 parts by weight, preferably 0.3-7.0 parts by weight, more preferably 0.4-6.0 parts by weight, very preferably 0.5-5.0 parts by weight of additives,
   with component D comprising at least one mould release agent and at least one stabilizer,
      with the sum of the parts by weight of all components making 100.

The individual preference ranges stated above for different components are freely combinable with one another.

In one preferred embodiment the composition consists only of components A to D.

In one preferred embodiment the composition is free from rubber-modified graft polymers.

Free from rubber-modified graft polymers means that less than 0.5 part by weight, preferably less than 0.1 part by weight, of this component is present in the composition.

In one preferred embodiment the composition is free from vinyl (co)polymers, more particularly SAN (styrene-acrylonitrile).

Free from vinyl (co)polymers, more particularly SAN (styrene-acrylonitrile), means that less than 0.5 part by weight, preferably less than 0.1 part by weight, of this component is present in the composition.

In one preferred embodiment the composition is free from vinyl (co)polymers and rubber-modified graft polymers.

Free from vinyl (co)polymers and free from rubber-modified graft polymers means that less than 0.5 part by weight, preferably less than 0.1 part by weight, of these components is present in the composition.

In one preferred embodiment the composition is free from phosphorus-based flame retardants.

Free from phosphorus-based flame retardants means that less than 0.5 part by weight, preferably less than 0.1 part by weight, of this component is present in the composition.

In one preferred embodiment the composition is free from carbon fibre.

Free from carbon fibres means that less than 0.5 part by weight, preferably less than 0.1 part by weight, of this component is present in the composition.

The weight ratio of component C to component B is preferably from 1:1 to 1:2.5.

Another preferred embodiment uses as component B polyalkylene terephthalates produced solely from terephthalic acid and reactive derivatives thereof (e.g. dialkyl esters thereof) and ethylene glycol and/or butanediol-1,4, and mixtures of these polyalkylene terephthalates.

Another preferred embodiment uses polyethylene terephthalate as component B.

In another preferred embodiment the compositions comprise
A) 55 to 65 parts by weight of at least one aromatic polycarbonate,
B) 21 to 25 parts by weight of at least one polyethylene terephthalate,
C) 9 to 21 parts by weight of at least one mineral filler based on talc having an upper particle size d₉₅ of less than 4.5 μm,
D) 0.5-5.0 parts by weight of additives,
   with component D comprising at least one mould release agent and at least one stabilizer,
      with the compositions being free from rubber-modified graft polymers, free from vinyl (co)polymers, free from phosphorus-based flame retardants and free from carbon fibres,
      and with the sum of the parts by weight of all components making 100.

In another preferred embodiment the compositions consist of:
A) 55 to 65 parts by weight of at least one aromatic polycarbonate,
B) 21 to 25 parts by weight of at least one polyethylene terephthalate,
C) 9 to 21 parts by weight of at least one mineral filler based on talc having an upper particle size d₉₅ of less than 4.5 μm,
D) 0.5-5.0 parts by weight of additives selected from the group consisting of lubricants and mould release agents, nucleating agents, stabilizers, antistats, dyes, pigments and fillers and reinforcing agents different from component C), with component D comprising at least one mould release agent and at least one stabilizer,
   with component D containing no carbon fibres,
      and with the sum of the parts by weight of all components making 100.

In another preferred embodiment the compositions consist of:
A) 55 to 65 parts by weight of at least one aromatic polycarbonate,
B) 21 to 25 parts by weight of at least one polyethylene terephthalate,
C) 9 to 21 parts by weight of at least one mineral filler based on talc having an upper particle size d₉₅ of less than 4.5 μm,
D) 0.5-5.0 parts by weight of additives selected from the group consisting of lubricants and mould release agents, nucleating agents, stabilizers, antistats, dyes, pigments and fillers and reinforcing agents different from component C),
   with component D comprising at least one mould release agent and at least two stabilizers, with the second stabilizer comprising a Brönstedt-acidic compound,
   with component D containing no carbon fibres,
      and with the sum of the parts by weight of all components making 100.

The preferred embodiments of the present invention may be implemented individually or else interlinked with one another.

### Component A

Aromatic polycarbonates and/or aromatic polyestercarbonates of component A that are suitable in accordance with the invention are known from the literature or can be prepared by methods known from the literature (on the preparation of aromatic polycarbonates see, for example, Schnell, “Chemistry and Physics of Polycarbonates”, Interscience Publishers, 1964, and also DE-B 1 495 626, DE-A 2 232 877, DE-A 2 703 376, DE-A 2 714 544, DE-A 3 000 610, DE-A 3 832 396; on the preparation of aromatic polyestercarbonates, for example DE-A 3 007 934).

Aromatic polycarbonates are prepared for example by reacting diphenols with carbonyl halides, preferably phosgene, and/or with aromatic dicarbonyl dihalides, preferably benzenedicarboxylic dihalides, by the interfacial process, optionally with use of chain terminators, for example monophenols, and optionally with use of trifunctional or more than trifunctional branching agents, examples being triphenols or tetraphenols. Also possible is their preparation via a melt polymerization process, through reaction of diphenols with, for example, diphenyl carbonate.

Diphenols for preparing the aromatic polycarbonates and/or aromatic polyestercarbonates are preferably those of the formula (I)

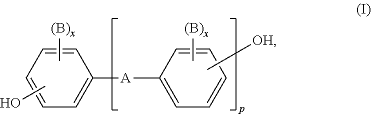

where
A is a single bond, C₁ to C₅ alkylene, C₂ to C₅ alkylidene, C₅ to C₆ cyclo-alkylidene, —O—, —SO—, —CO—, —S—, —SO₂—, C₆ to C₁₂ arylene, onto which further aromatic rings, optionally containing heteroatoms, may have been fused,
or a radical of the formula (II) or (III)

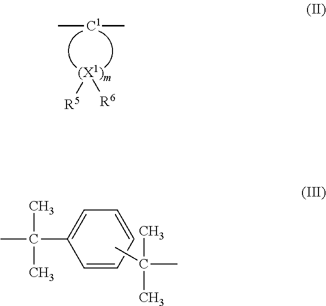

B is in each case C₁ to C₁₂ alkyl, preferably methyl, or halogen, preferably chlorine and/or bromine,
x in each case independently of one another is 0, 1 or 2,
p is 1 or 0, and
R⁵ and R⁶, selectable individually for each X¹, are independently of one another hydrogen or C₁ to C₆ alkyl, preferably hydrogen, methyl or ethyl,
X¹ is carbon and
m is an integer from 4 to 7, preferably 4 or 5, with the proviso that R⁵ and R⁶ are simultaneously alkyl on at least one atom X¹.

Preferred diphenols are hydroquinone, resorcinol, dihydroxydiphenols, bis(hydroxyphenyl)-C₁-C₅-alkanes, bis(hydroxyphenyl)-C₅-C₆-cycloalkanes, bis-(hydroxyphenyl) ethers, bis(hydroxyphenyl) sulphoxides, bis(hydroxyphenyl) ketones, bis(hydroxyphenyl) sulphones and α,α-bis(hydroxyphenyl)diisopropyl-benzenes and also their ring-brominated and/or ring-chlorinated derivatives.

Particularly preferred diphenols are 4,4′-dihydroxybiphenyl, bisphenol A, 2,4-bis(4-hydroxyphenyl)-2-methylbutane, 1,1-bis(4-hydroxyphenyl)cyclohexane, 1,1-bis(4-hydroxyphenyl)-3,3,5-trimethylcyclohexane, 4,4′-dihydroxydiphenyl sulphide, 4,4′-dihydroxydiphenyl sulphone and also their di- and tetrabrominated or -chlorinated derivatives such as, for example, 2,2-bis(3-chloro-4-hydroxyphenyl)-propane, 2,2-bis(3,5-dichloro-4-hydroxyphenyl)propane or 2,2-bis(3,5-dibromo-4-hydroxyphenyl)propane. Especially preferred is 2,2-bis(4-hydroxyphenyl)propane (bisphenol A).

The diphenols may be used individually or as any desired mixtures. The diphenols are known from the literature or are obtainable by methods known from the literature.

Examples of chain terminators suitable for preparing the thermoplastic aromatic polycarbonates are phenol, p-chlorophenol, p-tert-butylphenol or 2,4,6-tribromo-phenol, and also long-chain alkylphenols, such as 4-[2-(2,4,4-trimethylpentyl)]-phenol, 4-(1,3-tetramethylbutyl)phenol according to DE-A 2 842 005, or monoalkylphenol or dialkylphenols having a total of 8 to 20 carbon atoms in the alkyl substituents, such as 3,5-di-tert-butylphenol, p-isooctylphenol, p-tert-octylphenol, p-dodecylphenol and 2-(3,5-dimethylheptyl)phenol and 4-(3,5-dimethylheptyl)phenol. The amount of chain terminators to be used is generally between 0.5 mol % and 10 mol %, based on the molar sum of the diphenols used in each case.

The thermoplastic aromatic polycarbonates have average molecular weights (weight average M_{w}, measured by GPC (gel permeation chromatography) with polycarbonate standard) of 15,000 to 39,000 g/mol, preferably 19,000 to 32,000 g/mol, more preferably 20,000 to 30,000 g/mol.

The thermoplastic aromatic polycarbonates may be branched, in a known way, preferably through the incorporation of 0.05 to 2.0 mol %, based on the sum of the diphenols used, of trifunctional or more than trifunctional compounds, examples being those having three or more phenolic groups. Preference is given to using linear polycarbonates, more preferably based on bisphenol A.

Both homopolycarbonates and copolycarbonates are suitable. To prepare copolycarbonates of the invention as per component A, it is also possible to use 1 to 25 wt %, preferably 2.5 to 25 wt %, based on the total amount of diphenols to be used, of polydiorganosiloxanes having hydroxyaryloxy end groups. These compounds are known (U.S. Pat. No. 3,419,634) and can be prepared by methods known from the literature. Likewise suitable are polydiorganosiloxane-containing copolycarbonates; the preparation of the polydiorganosiloxane-containing copolycarbonates is described in DE-A 3 334 782, for example.

Aromatic dicarboxylic dihalides for the preparation of aromatic polyestercarbonates are preferably the diacyl dichlorides of isophthalic acid, terephthalic acid, diphenyl ether 4,4′-dicarboxylic acid and of naphthalene-2,6-dicarboxylic acid.

Particularly preferred are mixtures of the diacyl dichlorides of isophthalic acid and of terephthalic acid in a ratio between 1:20 and 20:1.

Additionally used in the preparation of polyestercarbonates is a carbonyl halide, preferably phosgene, as bifunctional acid derivative.

As chain terminators for the preparation of the aromatic polyestercarbonates, apart from the monophenols already stated, consideration is also given to their chlorocarbonic esters and also to the acyl chlorides of aromatic monocarboxylic acids, which may optionally be substituted with C₁ to C₂₂ alkyl groups or with halogen atoms, and also to aliphatic C₂ to C₂₂ monocarboxylic chlorides.

The amount of chain terminators is in each case 0.1 to 10 mol %, based in the case of the phenolic chain terminators on moles of diphenol and in the case of monocarboxylic chloride chain terminators on moles of dicarboxylic dichloride.

In the preparation of aromatic polyestercarbonates it is possible additionally to use one or more than one aromatic hydroxycarboxylic acid.

The aromatic polyestercarbonates may both be linear and also branched, in a known way (in this regard, see DE-A 2 940 024 and DE-A 3 007 934), with linear polyestercarbonates being preferred.

Branching agents used may be, for example, trifunctional or more highly polyfunctional carboxylic chlorides, such as trimesic trichloride, cyanuric trichloride, 3,3′,4,4′-benzophenonetetracarboxylic tetrachloride, 1,4,5,8-naphthalenetetracarboxylic tetrachloride or pyromellitic tetrachloride, in amounts of 0.01 to 1.0 mol % (based on dicarboxylic dichlorides used) or trifunctional or higher polyfunctional phenols, such as phloroglucinol, 4,6-dimethyl-2,4,6-tri(4-hydroxyphenyl)hept-2-ene, 4,6-dimethyl-2,4,6-tri(4-hydroxyphenyl)heptane, 1,3,5-tri(4-hydroxyphenyl)benzene, 1,1,1-tri(4-hydroxyphenyl)ethane, tri(4-hydroxyphenyl)phenylmethane, 2,2-bis [4,4-bis(4-hydroxyphenyl)cyclohexyl]propane, 2,4-bis(4-hydroxyphenylisopropyl)phenol, tetra(4-hydroxyphenyl)methane, 2,6-bis(2-hydroxy-5-methylbenzyl)-4-methylphenol, 2-(4-hydroxyphenyl)-2-(2,4-dihydroxyphenyl)propane, tetra(4-[4-hydroxyphenylisopropyl]phenoxy)methane, 1,4-bis [4,4′-dihydroxytriphenyl)-methyl]benzene, in amounts of 0.01 to 1.0 mol %, based on diphenols used. Phenolic branching agents can be introduced with the diphenols; acyl chloride branching agents may be introduced together with the acyl dichlorides.

The fraction of carbonate structural units in the thermoplastic aromatic polyestercarbonates may be varied as desired. The fraction of carbonate groups is preferably up to 100 mol %, more particularly up to 80 mol %, very preferably up to 50 mol %, based on the sum of ester groups and carbonate groups. Both the ester fraction and the carbonate fraction of the aromatic polyestercarbonates may be present in the form of blocks or statistically distributed in the polycondensate.

The thermoplastic aromatic polycarbonates and polyestercarbonates can be used alone or in any desired mixture.

### Component B

In accordance with the invention, component B are polyalkylene terephthalates. In a particularly preferred embodiment, these are reaction products of aromatic dicarboxylic acids or reactive derivatives thereof, such as dimethyl esters or anhydrides, with aliphatic, cycloaliphatic or araliphatic diols, and also mixtures of these reaction products.

Particularly preferred polyalkylene terephthalates contain at least 80 wt %, preferably at least 90 wt %, based on the dicarboxylic acid component, of terephthalic acid radicals, and at least 80 wt %, preferably at least 90 wt %, based on the diol component, of ethylene glycol and/or butane-1,4-diol radicals.

Besides terephthalic radicals, the preferred polyalkylene terephthalates may contain up to 20 mol %, preferably up to 10 mol %, of radicals of other aromatic or cycloaliphatic dicarboxylic acids having 8 to 14 C atoms or of aliphatic dicarboxylic acids having 4 to 12 C atoms, such as, for example, radicals of phthalic acid, isophthalic acid, naphthalene-2,6-dicarboxylic acid, 4,4′-biphenyldicarboxylic acid, succinic acid, adipic acid, sebacic acid, azelaic acid, cyclohexanediacetic acid.

Besides ethylene glycol and/or butane-1,4-diol radicals, the preferred polyalkylene terephthalates may contain up to 20 mol %, preferably up to 10 mol %, of other aliphatic diols having 3 to 12 C atoms or cycloaliphatic diols having 6 to 21 C atoms, examples being radicals of propane-1,3-diol, 2-ethylpropane-1,3-diol, neopentyl glycol, pentane-1,5-diol, hexane-1,6-diol, cyclohexane-1,4-dimethanol, 3-ethyl-pentane-2,4-diol, 2-methylpentane-2,4-diol, 2,2,4-trimethylpentane-1,3-diol, 2-ethyl-hexane-1,3-diol, 2,2-diethylpropane-1,3-diol, hexane-2,5-diol, 1,4-di(β-hydroxy-ethoxy)benzene, 2,2-bis(4-hydroxycyclohexyl)propane, 2,4-dihydroxy-1,1,3,3-tetra-methylcyclobutane, 2,2-bis(4-β-hydroxyethoxyphenyl)propane and 2,2-bis(4-hydroxypropoxyphenyl)propane (DE-A 2 407 674, 2 407 776, 2 715 932).

The polyalkylene terephthalates can be branched by incorporation of relatively small amounts of tri- or tetravalent alcohols or tri- or tetrabasic carboxylic acids, in accordance with DE-A 1 900 270 and U.S. Pat. No. 3,692,744, for example. Examples of preferred branching agents are trimesic acid, trimellitic acid, trimethylolethane and -propane, and pentaerythritol.

Particularly preferred are polyalkylene terephthalates produced solely from terephthalic acid and its reactive derivatives (e.g. its dialkyl esters) and ethylene glycol and/or butane-1,4-diol, and mixtures of these polyalkylene terephthalates.

Mixtures of polyalkylene terephthalates contain 1 to 50 wt %, preferably 1 to 30 wt %, of polyethylene terephthalate and 50 to 99 wt %, preferably 70 to 99 wt %, of polybutylene terephthalate.

Particular preference is given to using polyethylene terephthalate as component B.

The polyalkylene terephthalates used with preference preferably possess an intrinsic viscosity of 0.4 to 1.5 dl/g, preferably 0.5 to 1.2 dl/g in an Ubbelohde viscometer, measured in dichloroacetic acid in a concentration of 1 wt % at 25° C. in accordance with DIN 53728-3. The intrinsic viscosity determined is calculated from the measured specific viscosity×0.0006907+0.063096.

The polyalkylene terephthalates are preparable by known methods (see, for example, Kunststoff-Handbuch, volume VIII, p. 695ff, Carl-Hanser-Verlag, Munich, 1973).

### Component C

As component C, the thermoplastic moulding compounds comprise talc and/or mineral fillers based on talc as reinforcing agent, or a mixture of the aforementioned reinforcing agents and at least one further reinforcing agent not based on talc.

The further reinforcing agent is selected from the group consisting of mica, silicate, quartz, titanium dioxide, kaolin, amorphous silicas, magnesium carbonate, chalk, feldspar, barium sulphate, glass beads, ceramic beads, carbon fibres and glass fibres. In a preferred embodiment, talc or a mineral filler based on talc is the sole reinforcing agent.

Suitable mineral fillers based on talc in the sense of the invention are all particulate fillers which the skilled person associates with talc or talcum. Likewise suitable are all particulate fillers which are offered commercially and whose product descriptions include the terms talc or talcum as characteristic features.

Preferred mineral fillers are those having a talc content to DIN 55920 of greater than 50 wt %, preferably greater than 80 wt %, more preferably greater than 95 wt % and especially preferably greater than 98 wt %, based on the total mass of filler. By talc is meant a naturally occurring or synthetically produced talc.

Pure talc has the chemical composition 3 MgO.4SiO₂.H₂O and hence has an MgO content of 31.9 wt %, an SiO₂ content of 63.4 wt % and a chemically bound water content of 4.8 wt %. It is a silicate with a layer structure.

Naturally occurring talc materials generally do not possess the ideal composition presented above, since they carry impurities as a result of partial replacement of the magnesium by other elements, partial replacement of silicon, by aluminium, for example, and/or intergrowths with other minerals, such as dolomite, magnesite and chlorite, for example.

Varieties of talc employed with particular preference as component C are notable for particularly high purity, characterized by an MgO content of 28 to 35 wt %, preferably 30 to 33 wt %, more preferably 30.5 to 32 wt % and an SiO₂ content of 55 to 65 wt %, preferably 58 to 64 wt %, more preferably 60 to 62.5 wt %.

The particularly preferred talc types are further notable for an Al₂O₃ content of less than 5 wt %, more preferably less than 1 wt %, more particularly less than 0.7 wt %.

Particularly advantageous and, accordingly, preferred as well is the use of the talc of the invention in the form of finely ground types having an average particle size d₅₀ of 0.1 to 20 μm, preferably 0.2 to 10 μm, more preferably 0.5 to 5 μm, more preferably still 0.7 to 2.5 μm, and very preferably 1.0 to 2.0 μm.

The talc-based mineral fillers for use in accordance with the invention preferably have an upper grain or particle size d₉₅ of less than 10 μm, preferably less than 7 μm, more preferably less than 6 μm, and especially preferably less than 4.5 μm. The d₉₅ and d₅₀ values for the fillers are determined by sedimentation analysis with a SEDIGRAPH D 5 000 in accordance with ISO 13317-3.

The talc-based mineral fillers may optionally have been surface-treated to obtain more effective coupling to the polymer matrix. They may, for example, have been furnished with an adhesion promoter system based on functionalized silanes.

The average aspect ratio (diameter to thickness) of the particulate fillers is situated preferably in the 1 to 100 range, more preferably 2 to 25 and especially preferably 5 to 25, determined on electron micrographs of ultra-thin sections of the finished products, with measurement of a representative amount (around 50) of filler particles.

Owing to the processing to give the moulding compound and/or to form mouldings, the particulate fillers may have a smaller d₉₅ and/or d₅₀ value in the moulding compound and/or in the moulding than the fillers originally employed.

### Component D

The composition comprises customary polymer additives as component D.

Customary polymer additives as per component D include additives such as, for example, internal and external lubricants and mould release agents (for example pentaerythritol tetrastearate, montan wax or polyethylene wax), conductivity additives (for example conductive carbon black or carbon nanotubes), UV/light stabilizers, other stabilizers (for example, heat stabilizers, nucleation agents (e.g. sodium phenylphosphinate, aluminium oxide, silicon dioxide, salts of aromatic carboxylic acids), antioxidants, transesterification inhibitors, hydrolysis inhibitors), scratch resistance-improving additives (for example silicone oils), IR absorbers, optical brighteners, fluorescent additives, and also dyes and pigments (for example titanium dioxide, ultramarine blue, iron oxide, carbon black, phthalocyanines, quinacridones, perylenes, nigrosin and anthraquinones) and fillers and reinforcing agents different from component C), or else mixtures of a number of the stated additives.

The compositions of the invention comprise at least one mould release agent, preferably pentaerythritol tetrastearate, and at least one stabilizer, preferably a phenolic antioxidant and/or an organic phosphonate.

In one preferred embodiment the composition comprises as component D at least one adjuvant selected from the group consisting of lubricants and mould release agents, UV/light stabilizers, stabilizers, antistats, dyes, pigments and fillers and reinforcing agents different from component C).

Employed with further preference is a stabilizer combination composed of at least two stabilizers, the second stabilizer comprising a Brönstedt-acidic compound. The second stabilizer is preferably phosphorous acid or acidic phosphates, e.g. calcium monophosphate.

The additives may be used alone or in a mixture, or in the form of masterbatches.

The present invention further relates to mouldings produced from the above compositions, preferably sheetlike mouldings such as panels and bodywork components such as mirror housings, wheel surrounds, spoilers, bonnets, etc.

The compositions of the invention are produced by conventional methods, by mixing of the components. It may be advantageous to premix certain components. The mixing of components A to D and also, optionally, of further constituents takes place preferably at temperatures from 220 to 330° C. by joint compounding, extruding or rolling of the components.

The compositions of the invention can be processed by conventional methods to form preforms or mouldings of all kinds. Examples of processing methods include extrusion methods and injection moulding methods. Panels are an example of preforms.

The mouldings may be large or small parts and may be used for exterior or interior applications. Preference is given to producing large mouldings for vehicle construction, more particularly for the motor vehicle sector. From the moulding compounds of the invention it is possible in particular to manufacture exterior bodywork components such as, for example, wheel surrounds, tailgates, engine bonnets, bumpers, loading surfaces, covers for loading surfaces, car roofs or other ancillary bodywork components.

Mouldings and/or preforms made from the moulding compounds/compositions of the invention may be present in an assembly with further materials such as metal or plastic, for example. Following possible painting of exterior bodywork components, for example, paint films may be present directly on the moulding compounds of the invention and/or on the materials used in the assembly. The moulding compounds of the invention and/or the mouldings/preforms comprising the moulding compounds of the invention may be used by customary techniques of joining and assembling a plurality of components or parts, such as coextrusion, film insert moulding, injection insert moulding, adhesive bonding, welding, screwing or stapling, together with other materials or on their own, for the production of finished parts such as exterior bodywork components, for example.

The moulding compounds of the invention can also be used for numerous further applications. Mention may be made, for example, of their use in electrical engineering or in the construction sector. In the stated fields of use, mouldings formed from the moulding compounds of the invention may be employed, for example, as lamp covers, as coil formers, as safety glazing, as housing material for electronic devices, as housing material for household appliances, as panels for producing covers.

The compositions of the invention are notable for excellent heat distortion resistance and dimensional stability under heat. The compositions of the invention additionally have a low CLTE, in combination with good impact strength, high modulus of elasticity, good flowability, high heat distortion resistance and reduced contraction in the course of thermoplastic processing.

### EXAMPLES

### Component A

Linear polycarbonate based on bisphenol A, having a relative solution viscosity (ηᵣₑₗ) (measured on solutions of 0.5 g of polycarbonate in 100 ml of methylene chloride at 25° C.) of 1.255.

### Component B

Polyethylene terephthalate (e.g. PET from Invista, Germany) having an intrinsic viscosity of 0.623 dl/g, measured in dichloroacetic acid in a concentration of 1 wt % at 25° C.

### Component C

Talc having an average particle diameter D₅₀ of 1.2 μm and a D₉₅ of 3.5 μm as measured by Sedigraph, and having an Al₂O₃ content of 0.5 wt %.

### Component D-1

Pentaerythritol tetrastearate as lubricant/mould release agent

### Component D-2

Montan ester wax as lubricant/mould release agent

### Component D-3

Heat stabilizers

### Component D-4

Transesterification inhibitors

### Production of the Moulding Compounds

The moulding compounds of the invention, comprising components A to D, are produced on a ZSK25 twin-screw extruder from Coperion, Werner and Pfleiderer (Germany) at melt temperatures of 250° C. to 300° C.

### Production of the Test Specimens and Testing

The pellets resulting from the respective compounding operations were processed on an injection moulding machine (from Arburg) at a melt temperature of 270° C. and a mould temperature of 70° C. to form test specimens.

Melt flowability (MVR) is assessed on the basis of the melt volume flow rate (MVR) measured in accordance with ISO 1133 at a temperature of 270° C. and with a ram load of 5 kg.

Melt viscosity was determined in accordance with ISO 11443 at a temperature of 270° C. and shear rate of 1000 s⁻¹.

Heat distortion resistance was measured in accordance with DIN ISO 306 (Vicat softening temperature, method B with 50 N loading and a heating rate of 120 K/h) on a single-side-injected test rod with dimensions of 80×10×4 mm.

Notched impact strength (aₖ) and impact strength (aₙ) are determined in accordance with ISO 180/1A and ISO 180/1U, respectively, at room temperature (23° C.) by a 10-fold determination on test rods with dimensions of 80 mm×10 mm×4 mm.

Elongation at break and modulus of elasticity under tension are determined at room temperature (23° C.) in a method based on ISO 527-1,-2 on dumbbell specimens with dimensions of 170 mm×10 mm×4 mm.

The overall energy absorption in the puncture test is determined at room temperature (23° C.) in accordance with ISO 6603-2 by a 10-fold determination on test plaques with dimensions of 60 mm×60 mm×2 mm. The coefficient of linear thermal expansion (CLTE) is determined in accordance with DIN 53752 in a temperature range from 23° C. to 80° C. on a test specimen with dimensions of 60 mm×60 mm×2 mm, both parallel and perpendicular to the direction of melt flow during production of the test specimen.

Total contraction is determined in a method based on ISO 2577 on test plaques with dimensions of 150 mm×105 mm×3 mm. The injection-moulded test plaques were produced at a melt temperature of 270° C., a mould temperature of 70° C. and a holding pressure level of 600 bar. To determine total contraction, the plaques were conditioned at 90° C. for 1 hour. Total contraction is made up of processing contraction and subsequent contraction.

The examples which follow serve for further elucidation of the invention.

TABLE 1

| | | | | Ex. 1 | Ex. 2 | Ex. 3 | Ex. 4 | Ex. 5 |
|---|---|---|---|---|---|---|---|---|
| | | | | parts | parts | parts | parts | parts |
| | | | Component A | 60.12 | 60.12 | 60.12 | 60.12 | 60.12 |
| | | | Component B | 22.70 | 22.70 | 22.70 | 22.70 | 22.70 |
| | | | Component C | 5.00 | 10.00 | 15.00 | 20.00 | 25.00 |
| | | | Component D-1 | 0.17 | 0.17 | 0.17 | 0.17 | 0.17 |
| | | | Component D-2 | 0.40 | 0.40 | 0.40 | 0.40 | 0.40 |
| | | | Component D-3 | 0.30 | 0.30 | 0.30 | 0.30 | 0.30 |
| | | | Component D-4 | 1.31 | 1.31 | 1.31 | 1.31 | 1.31 |
| Testing | Standard | Conditions | Units | | | | | |
| MVR | ISO 1133 | 270° C./5 kg | cm³/10 min | 64 | 51 | 46 | 40 | 34 |
| Melt viscosity | ISO 11443 | 270° C./1000 s−1 | Pas | 179 | 194 | 196 | 209 | 219 |
| Vicat B | ISO 306 | 50 N/120 K/h | ° C. | 136 | 138 | 139 | 140 | 142 |
| Izod notched impact | ISO 180/1A | 23° C. | kJ/m² | 5.4 | 5.2 | 5.2 | 5.1 | 4.8 |
| strength | | | | | | | | |
| Izod impact strength | ISO 180/1U | 23° C. | kJ/m² | 72 | 67 | 54 | 40 | 39 |
| Tensile elasticity | ISO 527-1, -2 | 23° C. | N/mm² | 3299 | 3896 | 4517 | 5213 | 5918 |
| modulus | | | | | | | | |
| Elongation at break | ISO 527-1, -2 | 23° C. | % | 11.6 | 5.7 | 3.4 | 3.0 | 2.1 |
| Total energy puncture | ISO 6603-2 | 23° C. | J | 42.7 | 40.7 | 35.4 | 22.7 | 14 |
| test | | | | | | | | |
| CLTE | DIN 53752 | parallel | ppm * K⁻¹ | 60 | 53 | 44 | 38 | 37 |
| | | perpendicular | ppm * K⁻¹ | 61 | 55 | 49 | 44 | 41 |

| | | |
|---|---|---|
| Total contraction | based on ISO 2577 | Tₘ 270° C./Tₘₒ 70° C./HP 600 bar/conditioning 1 h at 90° C.* |

| | | | | | | |
|---|---|---|---|---|---|---|
| width contraction | % | 0.737 | 0.674 | 0.613 | 0.561 | 0.504 |
| length contraction | % | 0.667 | 0.607 | 0.556 | 0.524 | 0.460 |

*Tₘ = melt temperature, Tₘₒ = mould temperature, HP = holding pressure level

From Table 1 it is evident that the moulding compounds of the invention exhibit excellent heat distortion resistance (Vicat) in conjunction with good flowability (MVR), high impact strength (Izod), high modulus of elasticity and high energy absorption in the puncture test, and display an unexpectedly low CLTE.

The CLTE of the moulding compounds of the invention in longitudinal direction relative to transverse direction has a deviation preferably of not more than 20%, more preferably 15%.

The moulding compounds of the invention preferably have a CLTE (transverse) of 40 to 65 ppm/K, more preferably of 42-60 ppm/K.

The moulding compounds of the invention preferably have a CLTE (longitudinal) of 35 to 65 ppm/K, more preferably of 37.5-55 ppm/K.

The moulding compounds of the invention preferably have a modulus of elasticity of at least 3500 N/mm², more preferably of not more than 5500 N/mm².

The moulding compounds of the invention preferably have an MVR (270° C., 5 kg, 4 min preheating time) of at least 30, more preferably of at least 40, and more preferably still of not more than 65 cm³/10 min.

Furthermore, the compounds meet the requirements imposed on thermoplastic moulding compounds for exterior bodywork components of high surface area, in relation to stiffness (tensile modulus), extensibility (elongation at break), thermal expansion (coefficient of linear thermal expansion), flowability in the melt (MVR) and paintability (surface quality).

1. A composition comprising
A) 50 to 70 parts by weight of at least one aromatic polycarbonate,
B) 16 to 30 parts by weight of at least one polyalkylene terephthalate,
C) 4 to 30 parts by weight of at least one mineral filler based on talc,
D) 0.1-8.0 parts by weight of additives,
with component D comprising at least one mould release agent and at least one stabilizer and with the sum of the parts by weight of components A-D making 100.

2. The composition according to claim 1, wherein the composition is free from rubber-modified graft polymers.

3. The composition according to claim 1, wherein the composition is free from vinyl (co)polymers, including SAN (styrene-acrylonitrile).

4. A composition consisting of:
A) 50 to 70 parts by weight of at least one aromatic polycarbonate,
B) 16 to 30 parts by weight of at least one polyalkylene terephthalate,
C) 4 to 30 parts by weight of at least one mineral filler based on talc,
D) 0.1-8.0 parts by weight of additives selected from the group consisting of internal and external lubricants and mould release agents, conductivity additives, UV/light stabilizers, stabilizers, scratch resistance-improving additives, IR absorbers, optical brighteners, fluorescent additives, dyes and pigments and also fillers and reinforcing agents different from component C, and also mixtures of these additives, and
with component D comprising at least one mould release agent and at least one stabilizer and with the sum of the parts by weight of components A-D making 100.

5. The composition of claim 1, wherein component D is selected from the group consisting of lubricants and mould release agents, UV/light stabilizers, stabilizers, antistats, dyes and pigments and also fillers and reinforcing agents different from component C), with component D comprising at least one mould release agent and at least one stabilizer.

6. The composition of claim 1, wherein component B) is present at 21-25 parts by weight.

7. The composition of claim 1, wherein component C) is present at 9-21 parts by weight.

8. The composition of claim 1, wherein the weight ratio of component C to component B is from 1:1 to 1:2.5.

9. The composition of claim 1, wherein component C) has an upper particle size d₉₅ of less than 10 μm.

10. The composition of claim 1, wherein the composition has a CLTE (transverse) of 40 to 65 ppm/K.

11. The composition of claim 1, wherein the CLTE of the composition in longitudinal relative to transverse direction optionally has a deviation of max. 20%.

12. The composition of claim 1, wherein the composition has a modulus of elasticity of at least 3500 N/mm² and not more than 5500 N/mm².

13. The composition of claim 1, wherein the composition is free from carbon fibres.

14. A composition according to claim 1 capable of being used for producing injection-moulded and/or thermoformed mouldings.

15. A moulding produced from the composition according to claim 1.
